(19) United States
(12) Patent Application Publication
(10) Pub. No.: US 2010/0302045 A1
(43) Pub. Date: Dec. 2, 2010

(54) Interface for a fire alarm system

(76) Inventor: Andrew Foster, (US)

Correspondence Address: SALTER & MICHAELSON;THE HERITAGE BUILDING, 321 SOUTH MAIN STREET, PROVIDENCE, RI, 029037128, US

(21) Appl. No.: 12/455,232

(22) Filed: May 29, 2009

(51) Int. Cl. G08B 17/12

(52) U.S. Cl. 340/577

(57) ABSTRACT

An interface for a fire alarm system having a number of alarm condition detectors (11, 12, 13), a number of alarm devices such as alarm sounders (2) and the like and a fire alarm panel (1). The interface includes a fire alarm silence controller (4) and input and output circuits (7) and (8) connected to the controller. The input circuit includes one of the detectors (11) and the output circuit, one of the alarm sounders (2). Each fire alarm silence controller (4) has a timer and a user operable device for turning off the alarm device activated by the detector. The fire alarm system is provided for a plurality of individual dwellings and each dwelling has its own interface. When a detector in one dwelling is triggered to an alarm state the corresponding fire alarm silence controller operates the corresponding alarm device but does not signal an alarm condition to the fire alarm panel.

### TECHNICAL FIELD

This invention relates to an interface for a fire alarm system and to fire alarm systems including such an interface.

### BACKGROUND OF THE INVENTION

Fire alarm systems are known which comprise a plurality of smoke detectors, heat detectors, manual call points, alarm sounders and the like, sometimes known as input/output (I/O) devices. The invention is particularly concerned with devices where command and control protocols of one sort or another can be initiated by a control panel over some types of device but not necessarily all of the devices on a circuit individually. These “protocols” are mainly proprietary and relate to one manufacturer or another of the detection devices.

In a fire alarm system it is common for a detection device (I/O device) to either trigger into an alarm state or signal the presence of an adverse condition to the control panel. Furthermore, it is common for the control, panel to determine that an alarm condition has been reached by either sensing the triggered alarm state or determining that the adverse condition constitutes an alarm condition. The control panel then would normally initiate the alarm sounders, either on the same wiring circuit as the detection devices or a separate circuit as determined by its required functionality for the situation at hand.

Indeed, some detection devices contain within themselves an alarm sounder. These devices can be programmed so as to trigger the internal alarm sounder on activation of the associated detection device and be reset when the associated detection device is reset by the control equipment. This then presents the facility of giving an alarm condition from within the triggered detection device.

It is common in many countries for flats, apartments, houses in multiple occupancy, bedsits, student accommodation and like dwellings to have a fire alarm system fitted. It is also common for these dwellings to have cooking facilities within and for false alarms from smoke detectors detecting the like of “burnt toast” to issue. These false alarms are so common that in some countries separate and discrete firm alarm systems are required to be installed in every “dwelling”. It is also well known that heat detectors operate much more reliably but require the fire to be much more established before they trigger. Ideally, there should be some form of false alarm prevention for each dwelling and only one fire alarm system fitted to the building. This would require that some form of interface to the fire alarm panel be constructed that filters out in some way false alarms and only allows potentially legitimate alarms to signal the control equipment, this “interface” should also facilitate some level of control by the occupant of the dwelling, for instance to enable silencing of the dwelling alarm sounders.

We have now devised an interface to a fire alarm system that can perform such functionality.

### SUMMARY OF THE INVENTION

According to the present invention there is provided an interface for a fire alarm system having a fire alarm panel, at least one detector for detecting an alarm condition and an alarm device corresponding to the detector wherein the interface comprises a fire alarm silence controller, an input circuit and an output circuit connected to the controller, said input circuit comprising said at least one detector and said output circuit comprising said at least one alarm device, the fire alarm silence controller being responsive to the said at least one detector such that when the detector is triggered to an alarm state the fire alarm silence controller operates the corresponding alarm device but does not signal an alarm condition to the fire alarm panel.

In a preferred embodiment of the invention, the fire alarm silence controller comprises a timer, and also a user operable device for turning off the said alarm device activated by the said detector. Operation of the alarm device initiates a timing cycle of the timer. At the end of the timing cycle the fire alarm silence controller attempts to reset and thus rearm the detector and turn off the corresponding alarm device. If an alarm condition remains at the end of the timing cycle, then the detector would remain in the alarm state or would be retriggered to an alarm state. The fire alarm silence controller would operate the corresponding alarm device once again and then signal an alarm condition to the fire alarm panel. Dependant upon fire panel programming and local authority regulations, the fire alarm panel issues an instruction employing the appropriate protocol to the or each fire alarm silence controller to operate the alarm devices under its control. Where the fire alarm panel issues such an instruction, the user operable device for turning off the alarm device would be deactivated thus preventing the user turning off the alarm device. In an establishment comprising a number of individual dwellings, the corresponding fire alarm system would incorporate a fire alarm panel and a number of fire alarm silence controllers usually corresponding to and disposed within respective dwellings.

Subsequently turning off or silencing the fire alarm panel would operate to turn off all alarm devices in the dwellings under its control through respective fire alarm silence controllers except for the specific alarm device which has initially responded to the alarm condition. The or each alarm device would preferably be an audible device, a mechanical device such as a vibrating pager/pillow pad, or a visual device or a combination of two or more of these.

Preferably the fire alarm panel and circuitry are of the analogue addressable type in which every device connected to the “analogue loop” of circuitry would be addressable and the fire alarm silence controller would contain an addressing system (e.g. DIP switches) uniquely identifying the controller and thus dwelling to the fire alarm panel. Preferably power for the fire alarm silence controller is derived from the fire alarm panel via the fire alarm circuit wiring without affecting the functionality of this wiring. Preferably the fire alarm panel communicates with the devices by varying the voltage on the circuit, and the devices communicate with the panel by generating current pulses derived from the respective fire alarm circuit.

Preferably the fire alarm silence controller contains short circuit zone isolators operative to disconnect one part of the circuit wiring from another should a short circuit be detected on one point or the other.

Preferably the circuit is so monitored within the fire alarm silence controller that the controller is able to differentiate between the triggering of the different detectors connected to it, or two or more devices of the same sort simultaneously. Preferably there are selection links on board the fire alarm silence controller to effectively reduce the time period automatically to zero under certain combinations of detector devices, or the simultaneous operation of two devices. A typical scenario would be time period is zero for the activation of any single heat detector OR manually operated device such as a break glass call point OR two or more smoke detectors.

Preferably a second timer is provided operative to be activated by the user operable device but only whilst there is no alarm condition present on the respective alarm silence controllers detection circuitry or any other fault condition present. The activation of this timer would effectively disconnect the respective detection circuit and prevent triggering for the time period of the second timer.

Preferably the time periods of both timers would be variable for example two minutes approximately for the first timer and twenty minutes approximately for the second timer.

Preferably the or each fire alarm silence controller contains a fault beeper.

Preferably several links or devices/switches fulfilling a similar purpose are provided on the fire alarm silence controller so as to be able to select several optional modes of operation.

Preferably the fire alarm silence controller contains visible indicators on its facia including but not limited to power (green) fault (yellow) timer running (yellow) fire (red).

Preferably the fault light is illuminated (steady or flashing) if any fault is detected by the fire alarm silence controller on any of its input or output circuits or any other recognizable internal/external fault.

Preferably the green power light is illuminated whilst power is applied to the fire alarm silence controller.

Preferably the timer running yellow indicator is illuminated (steady or flashing) whilst any of the timers are active.

Preferably the fault beeper is silenced by the user operable device whilst a fault light is illuminated (but not whilst the dwelling sounders are sounding).

Preferably according to one of the link selectable options the beeper would sound for a short period (for example ten seconds approximately) before the end of the first or second timer periods and operating the user operable device during this period would extend the time period by initializing the first or second timer.

Preferably when any of the timers are running the timer running light will be illuminated (either flashing or steady).

Preferably when the fire alarm silence controller has been triggered by a device on its own detection circuit it will illuminate the red fire light in a steady condition.

Preferably when the fire alarm silence controller has been triggered by a signal from the fire alarm panel it will illuminate the fire light in an intermittent mode.

The user operable device is preferably a push button.

The invention also comprises a fire alarm system incorporating one or more interfaces as detailed above.

### DESCRIPTION OF THE DRAWINGS

In order that the invention may be more clearly understood, one embodiment thereof will now be described, by way of example, with reference to the accompanying drawings, in which:

FIG. 1 shows a block circuit diagram of a fire alarm circuit, and

FIG. 2 shows a diagram of a fire alarm silence controller forming part of the fire alarm circuit of FIG. 1.

### DETAILED DESCRIPTION

An interface is provided for a fire alarm system having a number of alarm condition detectors (1 1, 12, 13), a number of alarm devices such as alarm sounders (2) and the like and a fire alarm panel (1). The interface comprises a fire alarm silence controller (4) and input and output circuits (7) and (8) connected to the controller. The input circuit includes one of the detectors (11) and the output circuit, one of the alarm sounders (2). Each fire alarm silence controller (4) comprises a timer and a user operable device for turning off the alarm device activated by the detector. The power for the fire alarm silence controller may be derived from the fire panel or from an external source. The fire alarm system is provided for a plurality of individual dwellings and each dwelling has its own interface. When a detector in one dwelling is triggered to an alarm state the corresponding fire alarm silence controller operates the corresponding alarm device but does not signal an alarm condition to the fire alarm panel. Operation of the alarm device initiates a timing cycle of the timer. If an alarm condition remains at the end of the timing cycle the detector remains in the alarm state or would be retriggered to the alarm state. The fire alarm silence controller operates the corresponding alarm device once again and then signals an alarm condition to the fire alarm panel. The panel then issues appropriate instructions to each fire alarm silence controller to operate the alarm devices under its control. This enables “false alarms” in any one dwelling to be filtered out and thus prevents such false alarms placing the entire alarm system in an alarm condition.

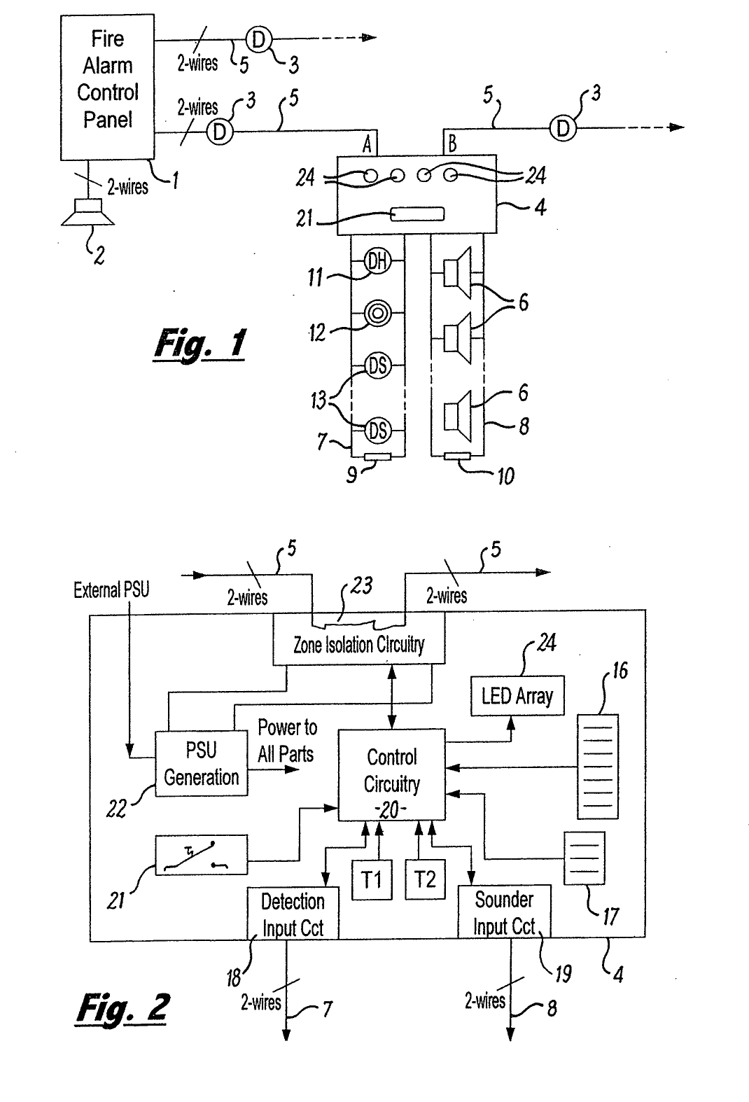

Referring to FIG. 1, the fire alarm circuit comprises a fire alarm having a fire alarm device in the form of a sounder (2) and fire alarm panel (1) connected to a fire alarm silence controller (4) via a standard wiring circuit (5) to which fire alarm devices (3) are connected. The fire alarm panel (1) communicates with the devices (3) and the fire alarm silence controller (4) by modulation of the circuit voltages using a “protocol” pertinent to that fire alarm panel (1), and those devices (3). The fire alarm silence controller (4) has an input circuit (7), to which detection devices (11), (13) and trigger devices such as break glass points (12) are connected, and an output circuit (8) to which fire alarm devices in the form of alarm sounders (6) would be connected.

The input circuit (7), output circuit (8) and fire alarm silence controller (4) constitute the dwelling fire alarm system, the fire alarm silence controller preferably being located within the dwelling. The input and output circuits are monitored by end of line units (9), (10) respectively to enable the fire alarm silence controller (4) to monitor the circuits for open and short circuit faults. The normal state of the fire alarm silence controller (4) would be benign with its internal circuitry constantly monitoring for faults or fire alarm conditions on all of its input and output wiring connections. The two circuits (9), (10) advantageously have one common wire to enable common wiring in three core cable. Preferably the two circuits may be wired as one circuit incorporating both detection and alarm devices.

Referring to FIG. 2, the fire alarm silence controller (4) comprises a microprocessor (20), a user operable device in the form of a press button (21) connected to the microprocessor, a power supply (22) connected to the wiring circuit (5) via zone isolators (23) and detector circuit generator and monitoring (18) and sounder circuit generator and monitoring (19). Two timers (T1) and (T2) and visual indicators (24) in the form of LED's are also provided.

The fire alarm panel (1) and circuitry (5) are of the analogue addressable type in which every device connected to the “analogue loop” of the circuitry (5) is addressable and the fire alarm silence controller (4) contains an addressing system comprising DIP switches (16) and links (17) uniquely identifying the controller and thus dwelling to the fire alarm panel (1).

Power for the fire alarm silence controller (4) is derived from the fire alarm panel (1) via the fire alarm circuitry (5) without affecting the functionality of this circuit. The short circuit zone isolators (23) operate to disconnect fire alarm circuit wiring side A from side B should a short circuit be detected on one side or the other.

The dwelling detection circuit (7) is so monitored within the fire alarm silence controller (4) that the controller is able to differentiate between the triggering of the different devices (11, 12, 13) connected to it, or two or more devices of the same sort simultaneously. Preferably there will be selection links on board the controller (4) to effectively reduce the time period of first timer (T1) automatically to zero under certain combinations of detected device or the simultaneous operation of two devices (smoke detectors 13). A typical scenario would be timer period of first timer is zero for the activation of any single heat detector OR manually operated device such as a break glass call point OR two or more smoke detectors.

The second timer (T2) is activated by the press button (21) but only whilst there is no alarm condition present on the respective alarm silence controller's detection circuitry (7) or any other fault condition present. The activation of this timer effectively disconnects the respective detection circuit (7) and prevents triggering for the time period of the timer (T2).

Preferably the time periods of both timers (T1) and (T2) are variable (T1 approx 2 minutes and T2 approx 20 minutes).

Preferably the fire alarm silence controller contains a fault beeper.

Preferably there are several links (or devices/switches fulfilling a similar purpose) on the fire alarm silence controller so as to be able to select several optional modes of operation.

The fire alarm silence controller's visible indicators (24) are disposed on its facia and include but are not limited to power (green) fault (yellow) timer running (yellow) fire (red).

Preferably the fault light would be illuminated (steady or flashing) if any fault was detected by the fire alarm silence controller on any of its input or output circuits or any other recognisable internal/external fault.

Preferably the green power light would be illuminated whilst power was applied to the fire alarm silence controller.

Preferably the timer running yellow indicator would be illuminated (steady or flashing) whilst any of the timers (T1) or (T2) are active.

Preferably the beeper is silenced by pressing the button (21) whilst a fault light is illuminated (but not whilst the dwelling sounders are sounding).

Preferably one of the link selectable options is that the beeper sounds approx ten seconds before the end of the timer periods (T1) or (T2), pressing the button (21) during this period would extend the time period by initialising timer (T1) or (T2).

Preferably when any of the timers (T1) or (T2) are running the timer running light will be illuminated (either flashing or steady).

Preferably when the fire alarm silence controller has been triggered by a device on its own detection circuit it will illuminate the red fire light in a steady condition.

Preferably when the fire alarm silence controller (4) has been triggered by a signal from the fire alarm panel (1) it will illuminate the fire light in an intermittent mode.

In a fire alarm system provided for a multiplicity of dwellings a plurality of fire alarm silence controllers (4) are disposed in respective dwellings all connected to a single fire alarm panel. The system operates as follows.

When a dwelling detection device (11, 12, 13) is triggered into an alarm state, by an alarm phenomena the corresponding fire alarm silence controller (4) triggers the dwelling alarm sounders (6) immediately, but does not signal a fire alarm condition to the fire alarm panel (1). This initiates a timer (T1) within the silence controller (4). Activation of the silence controller button (20) for example by an occupant of the dwelling would silence the dwelling sounders triggered in this manner. At the expiry of the time period or timer (T1) the silence controller (4) attempts to reset the detection circuit (7) and thus re-arm in the normal condition any triggered devices (11, 12, 13) as well as turning off the dwelling alarm sounders (6). If the alarm phenomena remains after the expiry of the time period of timer T1 then the respective device would re-trigger the silence controller (4) which would immediately resound the dwelling sounders (6) and signal an alarm condition to the fire alarm panel (1). Normally (but dependant on the fire panel programming and local authority regulations) the fire panel issues an instruction using the “protocol” over the wiring (5) or a plurality of such wiring to sound alarm sounders. Any dwelling with a fire alarm silence controller would respond to this signal by immediately triggering that respective dwelling's alarm sounder circuit (6) and thus that dwelling's fire alarm sounders. In this mode operation of the fire alarm silence controller's button (21) would have no effect. Silencing the fire alarm panel would have the effect of turning off these respective dwelling sounders in all dwellings save the dwelling with the triggered alarm condition.

It will be appreciated that the above embodiments has been described by way of example only and that many variations are possible within the scope of the invention.

What is claimed is:

1. An interface for a fire alarm system having a fire alarm panel, at least one detector for detecting an alarm condition and an alarm device corresponding to the detector wherein the interface comprises a fire alarm silence controller, an input circuit and an output circuit connected to the controller, said input circuit comprising said at least one detector and said output circuit comprising said at least one alarm device, the fire alarm silence controller being responsive to the said at least one detector such that when the detector is triggered to an alarm state the fire alarm silence controller operates the corresponding alarm device but does not signal an alarm condition to the fire alarm panel.

2. An interface for a fire alarm system having a fire alarm panel as claimed in claim 1, in which the fire alarm silence controller comprises a timer.

3. An interface for a fire alarm system having a fire alarm panel as claimed in claim 1, in which the fire alarm silence controller comprises a user operable device for turning off the alarm device activated by the fire alarm silence controller.

4. An interface for a fire alarm system having a fire alarm panel as claimed in claim 2, in which the alarm device is arranged so that operation thereof initiates a timing cycle of the timer.

5. An interface for a fire alarm system having a fire alarm panel as claimed in claim 4, in which the fire alarm silence controller (4) is adapted to reset and rearm the detector and turn off the corresponding alarm device at the end of the timing cycle.

6. An interface for a fire alarm system having a fire alarm panel as claimed in claim 4, in which the fire alarm silence controller is adapted to permit the detector to remain in the alarm state or to retrigger the detector to the alarm state if an alarm condition remains at the end of the timing cycle.

7. An interface for a fire alarm system having a fire alarm panel as claimed in claim 6, in which the fire alarm silence controller is adapted to operate the alarm device corresponding to the alarmed detector and to signal an alarm condition to the fire alarm panel.

8. An interface for a fire alarm system having a fire alarm panel as claimed in claim 7, in which the fire alarm panel is adapted to instruct the or each fire alarm silence controller to operate alarm devices under its control when the panel receives the alarm condition signal.

9. An interface for a fire alarm system having a fire alarm panel as claimed in claim 8, in which user operable means are associated with respective alarm devices for turning off the respective alarm device.

10. An interface for a fire alarm system having a fire alarm panel as claimed in claim 9, in which means are provided for deactivating the user operable means when the fire alarm panel operates to instruct the or each fire alarm silence controller to operate alarm devices under its control.

11. An interface for a fire alarm system having a fire alarm panel as claimed in claim 1, in which the or each alarm device is an audible device.

12. An interface for a fire alarm system having a fire alarm panel as claimed in claim 1, in which the or each alarm device is a mechanical device such as a vibrating pager/pillow pad.

13. An interface for a fire alarm system having a fire alarm panel as claimed in claim 1, in which the or each alarm device comprises a visual device.

14. An interface for a fire alarm system having a fire alarm panel as claimed in claim 1, in which the fire alarm panel is analogue addressable.

15. An interface for a fire alarm system having a fire alarm panel as claimed in claim 14, in which the fire alarm silence controller comprises an addressing system uniquely identifying the controller to the fire alarm panel.

16. An interface for a fire alarm system having a fire alarm panel as claimed in claim 14, in which the fire alarm silence controller comprises short circuit zone isolators operative to disconnect one part of the circuit wiring from another should a circuit be detected on one point or the other.

17. An interface for a fire alarm system having a fire alarm panel as claimed in claim 4, in which means are provided for reducing the period of the timing cycle under certain combinations of detector devices.

18. An interface for a fire alarm system having a fire alarm panel as claimed in claim 3 in which the fire alarm silence controller comprises a timer and in which a second timer is provided arranged for activation by the user operable device when no alarm condition is present in the alarm silence controller, operation thereof disconnecting the respective detection circuit and prevent triggering for the duration of the timing cycle of the second timer.

19. An interface for a fire alarm system having a fire alarm panel as claimed in claim 18, in which the period of the timing cycles of the timers is variable.

20. An interface as claimed in claim 1, in which power for the fire alarm silence controller is derived from the fire alarm panel.

21. An interface as claimed in claim 1, in which power for the fire alarm silence controller is supplied from an external power supply.

22. A fire alarm system incorporating one or more interfaces as claimed in claim 1.

23. A method of operating a fire alarm system for a plurality of dwellings comprising a fire alarm panel and a plurality of interfaces for respective dwellings, each interface having a fire alarm silence controller connected to an input circuit having an alarm detector and to an output circuit having an alarm device including the steps of detecting an alarm condition in one of the dwellings activating the corresponding alarm device but not the fire alarm panel thereby to prevent activation of alarm devices in other dwellings.
